(19) United States
(12) Patent Application Publication
(10) Pub. No.: US 2026/0213791 A1
(43) Pub. Date: Jul. 23, 2026

(54) METHOD AND DEVICE FOR TRANSMITTING/RECEIVING SIGNAL IN WIRELESS COMMUNICATION SYSTEM

(71) Applicant: LG Electronics Inc., Seoul (KR)

(72) Inventors: Jaeky OH, Seoul (KR); Ji Hwan JANG, Seoul (KR); Jaehoon CHUNG, Seoul (KR); Yecheng HE, Seoul (KR)

(21) Appl. No.: 19/115,958

(22) PCT Filed: Sep. 27, 2022
(86) PCT No.: PCT/KR2022/014409

§ 371 Date: Apr. 6, 2026

(51) Int. Cl. H04B 7/04; H04B 7/06

(52) U.S. Cl. CPC H04B 7/04013; H04B 7/0617

(57) ABSTRACT

In a wireless communication system, a terminal may receive at least one reference signal from a base station, generate channel state information after channel measurement based on the at least one reference signal, and feed the generated channel state information back to the base station. The at least one reference signal is a reference signal transmitted from the base station to the terminal through a reconfigurable intelligent surface (RIS) and first beamforming transmitted from the base station to the RIS may be determined based on feedback.

### CROSS-REFERENCE TO RELATED APPLICATIONS

This application is a National Stage application under 35 U.S.C. § 371 of International Application No. PCT/KR2022/014409, filed on Sep. 27, 2022. The disclosure of the prior application is incorporated by reference in its entirety.

### TECHNICAL FIELD

The following description relates to a wireless communication system, and to a method and device for transmitting and receiving signals at a terminal and a base station in a wireless communication system.

In particular, a terminal and a base station may provide a method and device for transmitting and receiving signals by controlling a radio channel environment through a reconfigurable intelligent surface (RIS).

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (mMTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure can provide a method and device for transmitting and receiving signals in a wireless communication system.

The present disclosure can provide a method of transmitting and receiving signals at a terminal and a base station using a RIS in a wireless communication system.

The present disclosure can provide a method of transmitting a synchronization signal and performing an initial connection using a RIS in a wireless communication system.

The present disclosure can provide a method of supporting multiple access using a RIS in a wireless communication system.

The present disclosure can provide a method of supporting non-orthogonal multiple access using a RIS in a wireless communication system.

The present disclosure can provide a method of supporting orthogonal multiple access using a RIS in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

As an example of the present disclosure, a method of operating a terminal in a wireless communication system may comprise receiving at least one synchronization signal block (SSB) from a base station, transmitting a preamble to the base station based on an SSB having a first index among the at least one SSB, receiving a random access response from the base station in response to the preamble, and performing an initial connection with the base station. Preset transmit beamforming may be formed between the base station and a reconfigurable intelligent surface (RIS), and the at least one SSB may be transmitted from the base station to the terminal through the RIS based on a reflection pattern of the RIS.

As an example of the present disclosure, a terminal in a wireless communication system may comprise a transceiver and a processor connected to the transceiver. The processor may control the transceiver to receive at least one synchronization signal block (SSB) from a base station, control the transceiver to transmit a preamble to the base station based on an SSB having a first index among the at least one SSB, control the transceiver to receive a random access response from the base station in response to the preamble, and perform an initial connection with the base station. Preset transmit beamforming may be formed between the base station and a reconfigurable intelligent surface (RIS), and the at least one SSB may be transmitted from the base station to the terminal through the RIS based on a reflection pattern of the RIS.

In addition, as an example of the present disclosure, a method of operating a base station in a wireless communication system may comprise transmitting at least one synchronization signal block (SSB), receiving a preamble from a terminal based on an SSB having a first index among the at least one SSB, transmitting a random access response to the terminal in response to the preamble, and performing an initial connection with the terminal. Preset transmit beamforming may be formed between the base station and a reconfigurable intelligent surface (RIS), and the at least one SSB may be transmitted from the base station to the terminal through the RIS based on a reflection pattern of the RIS.

In addition, as an example of the present disclosure, a base station in a wireless communication system may comprise a transceiver and a processor connected to the transceiver. The processor may control the transceiver to transmit at least one synchronization signal block (SSB), control the transceiver to receive a preamble from a terminal based on an SSB having a first index among the at least one SSB, control the transceiver to transmit a random access response to the terminal in response to the preamble, and perform an initial connection with the terminal. Preset transmit beamforming may be formed between the base station and a reconfigurable intelligent surface (RIS), and the at least one SSB may be transmitted from the base station to the terminal through the RIS based on a reflection pattern of the RIS.

In addition, as an example of the present disclosure, a device may comprise at least one memory and at least one processor functionally connected to the at least one memory. The at least one processor may control the device to receive at least one synchronization signal block (SSB) from a base station, transmit a preamble to the base station based on an SSB having a first index among the at least one SSB, receive a random access response from the base station in response to the preamble, and perform an initial connection with the base station. Preset transmit beamforming may be formed between the base station and a reconfigurable intelligent surface (RIS), and the at least one SSB may be transmitted from the base station to the terminal through the RIS based on a reflection pattern of the RIS.

In addition, as an example of the present disclosure, a non-transitory computer-readable medium storing at least one instruction may comprise the at least one instruction executable by a processor. The at least one instruction may perform control to receive at least one synchronization signal block (SSB) from a base station, perform control to transmit a preamble to the base station based on an SSB having a first index among the at least one SSB, perform control to receive a random access response from the base station in response to the preamble, and perform an initial connection with the base station. Preset transmit beamforming may be formed between the base station and a reconfigurable intelligent surface (RIS), and the at least one SSB may be transmitted from the base station to the terminal through the RIS based on a reflection pattern of the RIS.

In addition, the following may be commonly applied.

As an example of the present disclosure, the at least one SSB may be transmitted from the base station to the RIS based on the preset transmit beamforming, and each of SSBs having different indices among the at least one SSB may be transmitted to the terminal through a different beam based on the reflection pattern of the RIS.

In addition, as an example of the present disclosure, the terminal may measure a signal strength of the at least one SSB transmitted through each different beam, and select the SSB having the first index having a largest measured signal strength.

In addition, as an example of the present disclosure, the SSB may be a RIS-associated SSB, and the RIS-associated SSB may have an associated preamble and occasion.

In addition, as an example of the present disclosure, the RIS may transfer a signal received through the preset transmit beamforming from the base station to the terminal based on a first reflection pattern corresponding to the SSB having the first index.

In addition, as an example of the present disclosure, the number of terminals associated with the RIS and identification information of terminals may be transferred to the base station based on the initial connection, and the base station may perform multi-user access to the terminals associated with the RIS.

In addition, as an example of the present disclosure, the terminals associated with the RIS may perform communication with the base station through the RIS based on non-orthogonal multiple access (NOMA).

In addition, as an example of the present disclosure, the terminals associated with the RIS may perform communication with the base station through the RIS based on orthogonal multiple access.

In addition, as an example of the present disclosure, based on each of the terminals associated with the RIS performing communication with the base station through time division multiple access based on the RIS, the base station may generate RIS time division information based on the initial connection, the RIS time division information may be transferred from the base station to the RIS, and each of the terminals associated with the RIS may obtain RIS time division information of each of the terminals associated with the RIS from the base station.

In addition, as an example of the present disclosure, the RIS may transfer a signal received from the base station in a time interval corresponding to each of the terminals associated with the RIS based on the RIS time division information.

In addition, as an example of the present disclosure, based on each of the terminals associated with the RIS performing communication with the base station through frequency division multiple access based on the RIS, the RIS may generate a beam through each of sub-array RISs and the base station and the terminals associated with the RIS may perform communication based on the beam generated from each of the sub-array RISs.

In addition, as an example of the present disclosure, the base station may transfer a signal based on first transmit beamforming to a first sub-array RIS among the sub-array RISs in the RIS, and may transfer a signal to a first terminal among the terminals associated with the RIS through a beam formed based on the first sub-array RIS, and the base station may transfer a signal based on a second transmit beamforming to a second sub-array RIS among the sub-array RISs in the RIS, and may transfer a signal to a second terminal among the terminals associated with the RIS through a beam formed based on the second sub-array RIS.

In addition, as an example of the present disclosure, the first terminal may perform communication with the base station based on the first sub-array RIS through a first frequency, and the second terminal may perform communication with the base station based on the second sub-array RIS through a second frequency.

In addition, as an example of the present disclosure, the sub-array RIS control value may be generated by the base station through channel information of each of the terminals associated with the RIS based on the initial connection, and the sub-array RIS control value may be transferred to the RIS.

In addition, as an example of the present disclosure, an initial recognition mode may be determined based on the number of sub-arrays in the RIS and a minimum number of beams.

In addition, as an example of the present disclosure, the initial recognition mode may be determined based on the number of sub-arrays and the minimum number of beams that satisfy a frequency rate direction constant derived based on frequency rate learning information of a terminal direction, based on there being no combination of the number of sub-arrays and the minimum number of beams that satisfy the frequency rate direction constant, the number of sub-arrays may be set to 1, and based on the number of sub-arrays being 1, the RIS may generate a fixed spherical wave

In addition, as an example of the present disclosure, the terminal may obtain at least one of reward information and channel state information, and generate the sub-array RIS control value through at least one of the reward information or the channel state information.

As is apparent from the above description, the embodiments of the present disclosure have the following effects.

A terminal and a base station can transmit and receive signals using a RIS according to embodiments based on the present disclosure.

It is possible to transmit a synchronization signal and perform an initial connection using a RIS according to embodiments based on the present disclosure.

It is possible to support multiple connections using a RIS according to embodiments based on the present disclosure.

It is possible to support non-orthogonal multiple access using a RIS by embodiments based on the present disclosure.

It is possible to support orthogonal multiple access using a RIS by embodiments based on the present disclosure.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### BRIEF DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 is a view showing an example of a communication system applicable to the present disclosure.

FIG. 2 is a view showing an example of a wireless apparatus applicable to the present disclosure.

FIG. 3 is a view showing another example of a wireless device applicable to the present disclosure.

FIG. 4 is a view showing an example of artificial intelligence (AI) device applicable to the present disclosure.

FIG. 5 is a diagram showing a radio channel environment according to an embodiment of the present disclosure.

FIG. 6 is a diagram showing a smart radio environment according to an embodiment of the present disclosure.

FIGS. 7A and 7B are a diagram showing an existing radio channel environment and a smart radio channel environment according to an embodiment of the present disclosure.

FIG. 8 is a diagram illustrating a method of performing optimization in a smart radio channel environment according to an embodiment of the present disclosure.

FIG. 9 is a diagram illustrating a trust region according to an embodiment of the present disclosure

FIG. 10 is a diagram illustrating a shadow-area wireless communication environment that enables multi-use access using a reconfigurable intelligent surface (RIS) according to an embodiment of the present disclosure.

FIG. 11 is a diagram showing a RIS initial recognition mode according to an embodiment of the present disclosure.

FIG. 12 is a diagram showing a signal flow between a base station, a terminal, and a RIS for initial connection of a terminal in a wireless communication environment according to an embodiment of the present disclosure.

FIG. 13 is a diagram showing a signal flow between a base station, a terminal, and a RIS for initial connection of a terminal in a wireless communication environment according to an embodiment of the present disclosure.

FIG. 14 is a diagram illustrating a method of supporting multi-user access through a RIS based on orthogonal multiple access according to an embodiment of the present disclosure.

FIG. 15 is a diagram illustrating a method of supporting multi-user access through a RIS based on orthogonal multiple access according to one embodiment of the present disclosure.

FIG. 16 is a diagram illustrating a method of supporting multiple access through a RIS in a frequency division multiple access (FDMA) method according to an embodiment of the present disclosure.

FIG. 17 is a diagram illustrating a method of supporting multiple access by considering a channel environment in an environment where a base station and a sub-RIS are spatially separated according to an embodiment of the present disclosure.

FIG. 18 is a diagram illustrating a method of supporting multi-user access through a RIS based on an FDMA method according to an embodiment of the present disclosure.

FIG. 19 is a diagram illustrating a method of generating a sub-array RIS control value according to an embodiment of the present disclosure.

FIG. 20 is a diagram illustrating a method of generating a sub-array RIS control value according to an embodiment of the present disclosure.

FIG. 21 is a flowchart illustrating a method of setting an initial recognition mode based on a frequency rate according to an embodiment of the present disclosure.

FIG. 22 is a diagram illustrating a method of generating a sub-array RIS value considering beam interference based on artificial intelligence according to an embodiment of the present disclosure.

FIG. 23 is a diagram illustrating a method of generating a sub-array RIS value considering beam interference based on artificial intelligence according to an embodiment of the present disclosure.

FIG. 24 is a flowchart illustrating terminal operation according to an embodiment of the present disclosure.

FIG. 25 is a flowchart illustrating base station operation according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

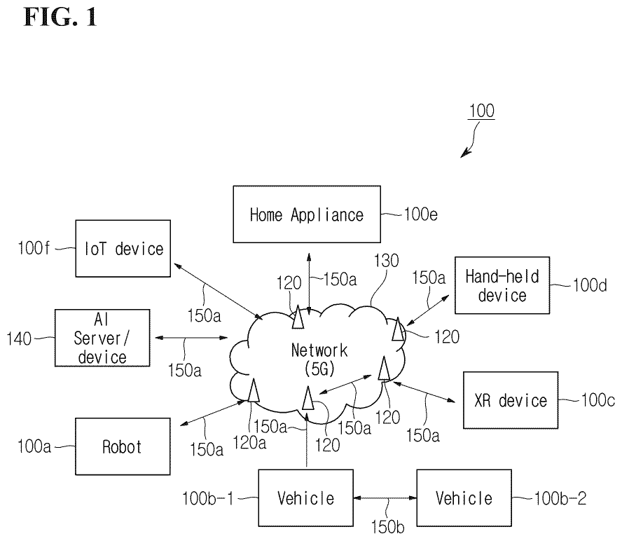

FIG. 1 is a view showing an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

### Communication System Applicable to the Present Disclosure

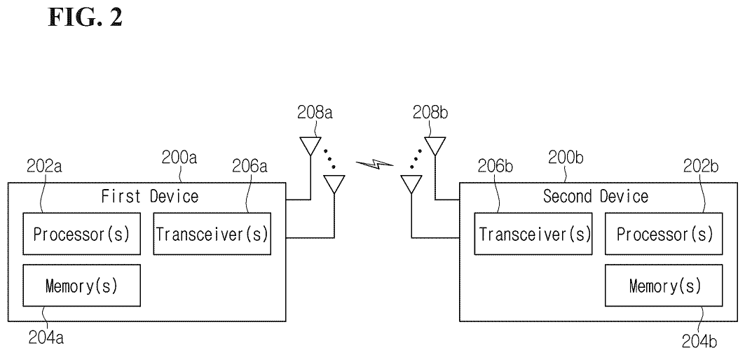

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

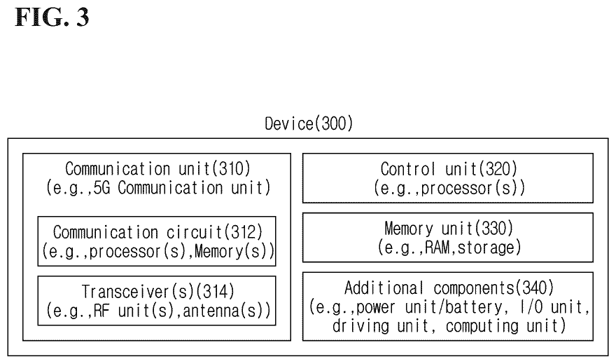

FIG. 3 is a view showing another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

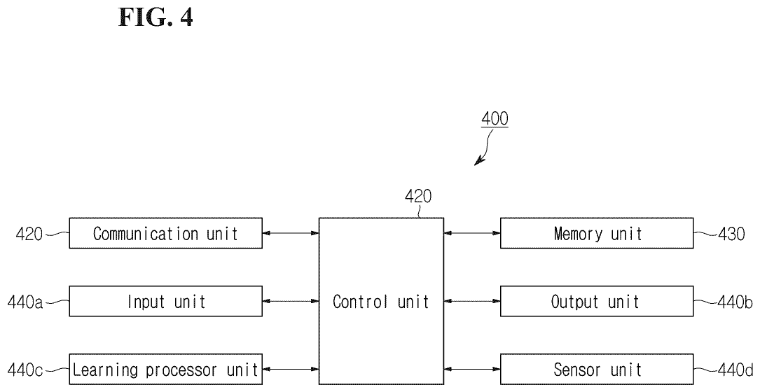

FIG. 4 is a view showing an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 4, the AI device 400 may include a communication unit 410, a control unit 420, a memory unit 430, an input/output unit 440a/440b, a learning processor unit 440c and a sensor unit 440d. Blocks 410 to 430/440A to 440D may correspond to blocks 310 to 330/340 of FIG. 3, respectively.

The communication unit 410 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 410 may transmit information in the memory unit 430 to an external device or send a signal received from an external device to the memory unit 430.

The control unit 420 may determine at least one executable operation of the AI device 400 based on information determined or generated using a data analysis algorithm or machine learning algorithm. In addition, the control unit 420 may control the components of the AI device 400 to perform the determined operation. For example, the control unit 420 may request, search, receive, or utilize the data of the learning processor 440c or the memory unit 430, and control the components of the AI device 400 to perform predicted operation or operation determined to be preferred among at least one executable operation. In addition, the control unit 420 collects history information including a user's feedback on the operation content or operation of the AI device 400, and stores it in the memory unit 430 or the learning processor 440c or transmit it to an external device such as the AI server (140 in FIG. 1). The collected history information may be used to update a learning model.

The memory unit 430 may store data supporting various functions of the AI device 400. For example, the memory unit 430 may store data obtained from the input unit 440a, data obtained from the communication unit 410, output data of the learning processor unit 440c, and data obtained from the sensor unit 440. Also, the memory unit 430 may store control information and/or software code required for operation/execution of the control unit 420.

The input unit 440a may obtain various types of data from the outside of the AI device 400. For example, the input unit 420 may obtain learning data for model learning, input data to which the learning model is applied, etc. The input unit 440a may include a camera, a microphone and/or a user input unit, etc. The output unit 440b may generate audio, video or tactile output. The output unit 440b may include a display unit, a speaker and/or a haptic module. The sensor unit 440 may obtain at least one of internal information of the AI device 400, surrounding environment information of the AI device 400 or user information using various sensors. The sensor unit 440 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 440c may train a model composed of an artificial neural network using learning data. The learning processor unit 440c may perform AI processing together with the learning processor unit of the AI server (140 in FIG. 1). The learning processor unit 440c may process information received from an external device through the communication unit 410 and/or information stored in the memory unit 430. In addition, the output value of the learning processor unit 440c may be transmitted to an external device through the communication unit 410 and/or stored in the memory unit 430.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 1 shows the requirements of the 6G system.

TABLE 1

| | |
|---|---|
| Per device peak data rate | 1 Tbps |
| E2E latency | 1 ms |
| Maximum spectral efficiency | 100 bps/Hz |
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

### Artificial Intelligence (AI)

The most important and newly introduced technology for the 6G system is AI. AI was not involved in the 4G system. 5G systems will support partial or very limited AI. However, the 6G system will support AI for full automation. Advances in machine learning will create more intelligent networks for real-time communication in 6G. Introducing AI in communication may simplify and enhance real-time data transmission. AI may use a number of analytics to determine how complex target tasks are performed. In other words, AI may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCI). AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals. In order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning, unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output layer to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning, a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

Hereinafter, a method of controlling a radio channel environment using a reconfigurable intelligent surface (RIS) will be described. In addition, the reconfigurable intelligent surface may be an Intelligent Reflect Surface (IRS). In other words, the reconfigurable intelligent surface may have various forms and may not be limited to a specific name. In the following, for convenience of explanation, the RIS will be focused upon, but the present disclosure may not be limited thereto. Here, an artificial intelligence system may be used to control a radio channel environment using a RIS, which will also be described later.

For example, current wireless communication technology may be controlled through endpoint optimization that adapts to a channel environment (H). For example, when optimization is performed at a transmitter and receiver, the transmitter and receiver may increase transmission efficiency by adjusting at least one of beamforming, power control, or adaptive modulation to the channel environment (H) between the transmitter and receiver.

At this time, the channel environment may be random, uncontrolled, and naturally fixed. That is, in the existing communication system, a method of controlling each endpoint to be optimized for the channel environment in a state in which the channel environment is fixed could be performed. Therefore, the transmitter and receiver shall perform optimization to adapt to the channel, and transmit and receive data through this. At this time, in an environment of non-line of sight (NLOS) in a shadow area or an environment where signal loss is high and multipath is difficult to exist, such as 6G THz, it may be difficult to overcome Shannon's Capacity Limit by optimizing only the endpoint, and thus it may be difficult to expect throughput as high as the desired requirement.

Considering the above, in a new communication system, communication may be performed based on a smart radio environment. In this case, in a smart radio environment, a reconfigurable intelligent surface (RIS) may be used as a factor that can control a radio channel along with a transceiver.

That is, a factor for the radio channel may be added as a factor used to optimize wireless communication transmission. Through this, it is possible to reset the channel or overcome Shannon's channel capacity limit, which is an unsolvable problem in the existing communication system. However, in a smart radio wireless environment, there is a need to optimize by considering the measurement of the added channel due to the reconfigurable intelligent surface (RIS), the reconfigurable intelligent surface (RIS) and the transceiver simultaneously, thus the optimization process may become complicated.

For example, there may be limitations in controlling the RIS using an Alternating Optimization (AO) algorithm applied in a smart radio environment along with the limitations of current wireless communication technology.

More specifically, in the existing communication systems, operation could be possible in a way that approached Shannon's channel capacity limit through the control of transmitters and receivers in a fixed radio channel environment. However, in poor NLOS environments such as shadow areas, transmission and reception may be almost impossible due to channel capacity limitations. For example, in an NLOS channel environment, the transmitter can improve the channel capacity limit by increasing power, but the magnitude of noise and interference may also increase accordingly. At this time, in an environment where signal loss is high and multipaths are difficult to exist, such as a 6G THz environment, there may be limitations in overcoming Shannon's channel capacity limit by only optimizing the transmitter and receiver.

Here, as an example, in a new communication system (e.g., 6G), there is a need to satisfy requirements for providing new services such as Mobile Broadband Reliable Low Latency Communication (MBRLLC), Massive Ultra-Reliable, Low Latency communications (mURLLC), Human-Centric Services (HCS) and Convergence of Communications, Computing, Control, Localization, and Sensing (3CLS), and for this purpose, communication based on a smart radio environment may be required.

In addition, as an example, many relays are currently used to increase the coverage of base station cells and support shadow areas. However, although the method of using relays can increase transmission efficiency, it may additionally generate interference signals for other users. Therefore, there may be limitations in terms of overall communication resource efficiency. In addition, the use of relays also requires high additional costs and energy, and complex and mixed interference signal management may not be easy. In addition, as an example, the spectrum efficiency may decrease by using the half duplex method, and it may also affect space utilization and aesthetics.

On the other hand, in a smart radio environment, the radio channel environment may be controlled by using a reconfigurable intelligent surface (RIS). At the same time, the transmitter and receiver may perform optimization together to provide a solution to overcome Shannon's channel capacity limit in the smart radio environment, which will be described later.

However, in addition to the existing channel between the base station and the terminal, there is also a need to consider the channel between the base station-RIS and the RIS-terminal. In addition, while it was sufficient to optimize only the transceiver to suit the environment in the past, in the smart radio environment, there is a need to control the reconfigurable intelligent surface (RIS) as well.

In addition, the value may have optimization and dependency of the transceiver, which may increase complexity. Here, the Alternating Optimization (AO) algorithm used for optimization may be performed repeatedly until convergence, which may cause a burden that all channels must be measured. Hereinafter, a method of performing optimization in a smart radio environment using a reconfigurable intelligent surface and an artificial intelligence system by considering the above-mentioned points will be described.

Also, as an example, Table 2 may show terms that consider points described above and below, and hereinafter, a method of performing optimization in a smart radio environment using a reconfigurable intelligent surface and an artificial intelligence system will be described based on this.

TABLE 2
RIS: Reconfigurable intelligent surface
IRS: Intelligent reflect surface
SRE: Smart radio environment
Mobile Broadband Reliable Low Latency Communication (MBRRLLC):
6G service requiring high speed, high reliability-low latency (e.g., BCI)
mMTC: Massive Machine Type communications
Massive Ultra-Reliable, Low Latency communications (mURLLC):
mMTC + URLLC
quality-of-physical-experience (QoPE): QOS + QOE + physiological
response
Human-Centric Services (HCS): communication based on QoPE
3CLS: Convergence of Communications, Computing, Control,
Localization, and Sensing

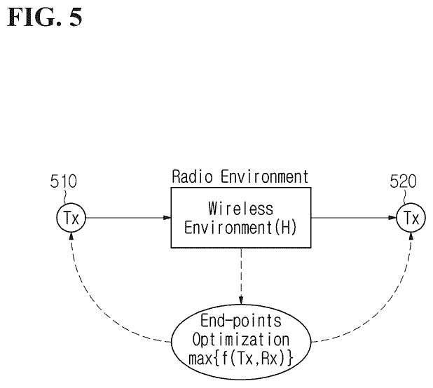

FIG. 5 is a diagram showing a radio channel environment according to an embodiment of the present disclosure. Referring to FIG. 5, in the existing communication system, the radio channel environment (H) is naturally fixed and may be a random state that cannot be controlled. Therefore, a transmitter 510 and a receiver 520 may find an optimized transmission and reception method by adapting to the channel. The transmitter 510 and the receiver 520 may be controlled to measure the channel state through a signal (e.g., a reference signal) and perform optimization based on the measured channel state. However, as described above, in a terahertz environment where signal loss is high and multipath application is difficult, and in an NLOS environment such as a shadow area, there may be a limit to data transmission. For example, Equation 1 below may represent Shannon's capacity limit. At this time, in Equation 1, even if the transmission signal P is increased by applying precoding and processing, there may be a limit to increasing the channel capacity if the size of the channel |H| is small.

In a fixed radio channel environment, there may be a limit to increasing the channel capacity based on Equation 1. At this time, if a reconfigurable intelligent surface (RIS) is used, multiple paths may be secured between the transmitter 510 and the receiver 520, and the channel |H| described above can be increased. That is, in an intelligent wireless environment, the radio channel environment can be an adjustable factor based on an intelligent reflector, and through this, the channel capacity can be increased.

$$C = log ( 1 + \frac{{\vert HP \vert}^{2}}{{σ}^{2}} ) \qquad [ Equation 1 ]$$

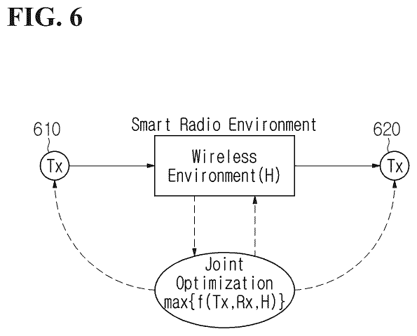

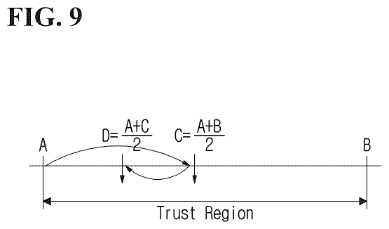

FIG. 6 is a diagram showing a smart radio environment according to an embodiment of the present disclosure. Referring to FIG. 6, in a smart radio channel environment, a radio channel |H| may be a factor for optimization. More specifically, in FIG. 9 described above, optimization may be performed at a transmitter 610 and a receiver 620 based on “max{f(Tx, Rx)}” as endpoint optimization, as described above. However, in FIG. 6, optimization may be performed at the transmitter 610 and the receiver 620 based on “max{f(Tx, Rx, H)}” as endpoint optimization. That is, in a smart radio environment, a channel |H| may be used as a factor for optimization based on a reconfigurable intelligent surface.

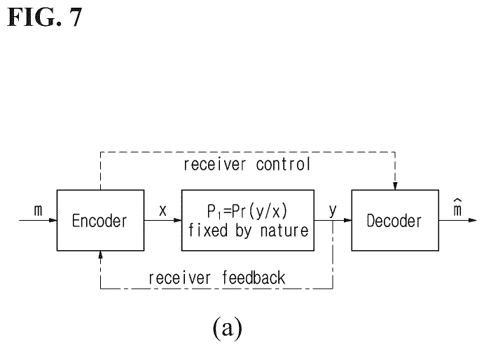

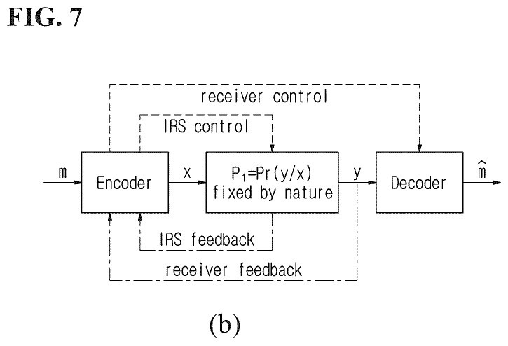

FIGS. 7A and 7B are a diagram showing an existing radio channel environment and a smart radio channel environment according to an embodiment of the present disclosure. For example, referring to FIG. 7A, the existing radio channel environment may be P1. Also, referring to FIG. 7B, the smart radio channel environment may be P2. At this time, when the x signal is transmitted from the transmitter through the radio channel in FIG. 7A and FIG. 7B, the receiver may receive the y signal. At this time, the probability of P1 in the existing radio channel environment is fixed, and a receiver (decoder) may transmit feedback to a transmitter through measurement of a transmission signal. The transmitter may perform optimization so as to adapt to the radio channel environment through the feedback of the receiver. As a more specific example, the receiver may measure a Channel Quality Indicator (CQI) for the transmission signal based on a reference signal transmitted by the transmitter and feed it back. The transmitter may adjust a modulation coding scheme (MCS) based on the fed-back information and provide information about it to the receiver to perform communication.

On the other hand, referring to FIG. 7B, in an smart radio channel environment, the radio channel environment P2 is recognized, and the radio channel environment may be changed through RIS control. At the same time, the receiver may perform measurement on the received transmission signal and transmit feedback thereon to the transmitter. That is, the transmitter may perform optimization by receiving feedback information based on RIS control and feedback information of the receiver. At this time, the transmitter may change the radio channel environment by adjusting the RIS, and optimization considering the radio channel environment and the transmitter may be performed.

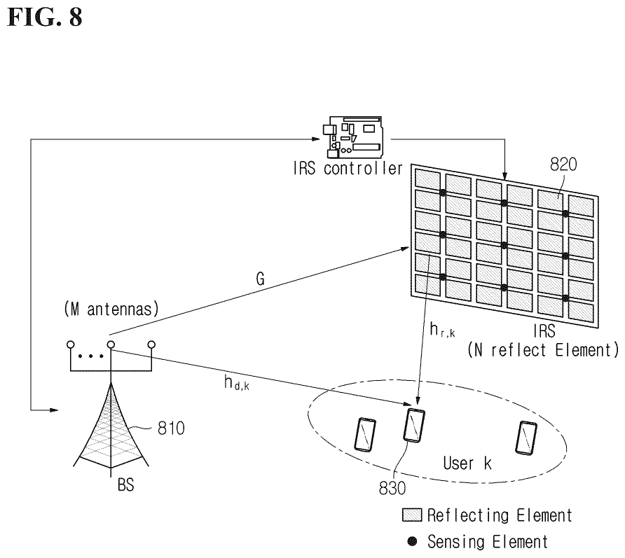

More specifically, FIG. 8 is a diagram illustrating a method of performing optimization in a smart radio channel environment according to an embodiment of the present disclosure. Referring to FIG. 8, a RIS 820 may be present between a base station 810 and a terminal 830 in a smart radio channel environment. For example, a signal transmitted by the base station 810 may have a path through which it is directly transmitted to the terminal 830 and a path through which it is reflected from the RIS 820 and transmitted. That is, in a smart channel environment, a radio channel G between the base station 810 and the RIS 820, a radio channel h_{r,k} between the RIS 820 and the terminal 830, and a direct radio channel h_{d,k} between the base station 810 and the terminal 830 may be present. Here, the radio channel G between the base station 810 and the RIS 820 and the radio channel h_{r,k} between the RIS 820 and the terminal 830 may be changed based on the control of the RIS 820. Therefore, in a smart radio channel environment, optimization may be performed by considering the radio channel environment described above.

More specifically, when the base station 810 transmits a signal to terminal k 830, the base station transmit beamforming vector for terminal k 830 may be wₖ, the signal transmitted to terminal k 830 may be sₖ, and reception noise may be nₖ. At this time, the signal received from the base station 810 based on the environment in which terminal k 830 uses the RIS 820 may be as shown in Equation 2 below, and for each channel, may be as shown in Table 3 below.

$$y = ( {h}_{r , k} Φ G + {h}_{d , k} ) {w}_{k} {s}_{k} + {n}_{k} \qquad [ Equation 2 ]$$

```
TABLE 3
  - h_{d,k} ϵ [symbol] ^{1×M}: Channel from BS to user k, h_{r,k} ϵ [symbol] ^{1×N}: Channel from IRS
to user k
  - G ϵ [symbol] ^{N×M}: Channel from BS to IRS, wₖ ϵ [symbol]  ^{M×1}: transmit beam-
forming vector for signal sₖ
  -Φ = diag(β1e^{jθ1} ... βNe^{jθN}): Phase and amplitude coefficient for element
n, β ϵ [0,1] , θ ϵ [0, 2π]
  $- {n}_{k} ∼ C 𝒩 ( 0 , {σ}_{k}^{2} ) : AWGN at user k$
```

Here, the signal-to-noise ratio (SNR) received by terminal k 830 may be as shown Equation 3 below.

$$γ = \frac{( {h}_{r , k} Φ G + {h}_{d , k} ) {w}_{k}}{{σ}_{k}^{2}} \qquad [ Equation 3 ]$$

Therefore, when configuring a smart radio environment (SRE) to optimize the reception SNR, it may be a case where the control of the IRS and the transmit beamforming are set as in Equation 4 below.

$${max}_{{w}_{k} , Φ} \frac{{\vert ( {h}_{r , k} Φ G + {h}_{d , k} ) {w}_{k} \vert}^{2}}{{σ}_{k}^{2}} \qquad [ Equation 4 ]$$

At this time, considering the maximum-rate transmit in MIMO, the transmit beamforming wₖ of terminal k 830 may be as shown in Equation 5 below.

$${w}_{k}^{*} = \sqrt{{P}_{max}} \frac{{( {h}_{r , k} Φ G + {h}_{d , k} )}^{H}}{‖ ( {h}_{r , k} Φ G + {h}_{d , k} ) ‖} \qquad [ Equation 5 ]$$

where, Pₘₐₓ may be maximum transmission power in IRS, and when

$${w}_{k}^{*}$$

is substituted into the equation for optimizing wₖ and Φ, the optimization may be as shown in Equation 6 below.

$${max}_{Φ} {‖ {h}_{r , k} Φ G + {h}_{d , k} ‖}^{2} , s . t . \vert {Φ}_{i , i} \vert = 1 , ∀ i = 1 , 2 , 3 , … , N \qquad [ Equation 6 ]$$

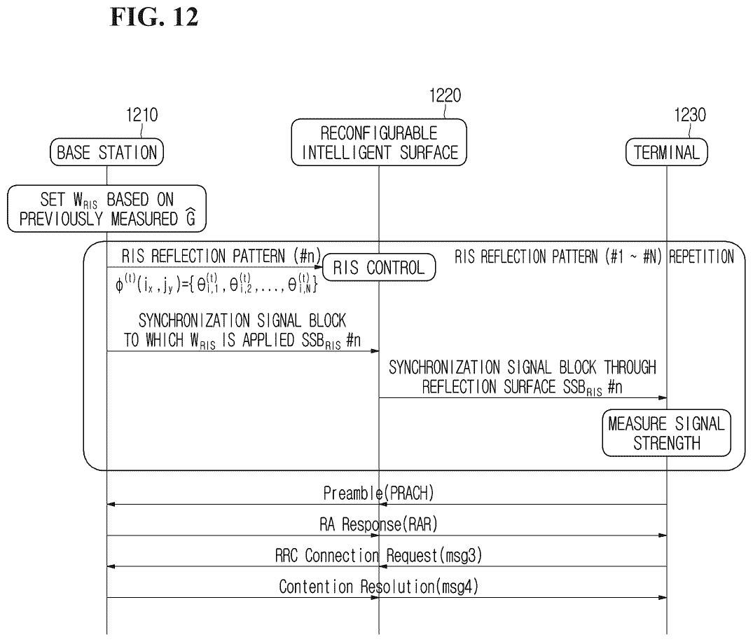

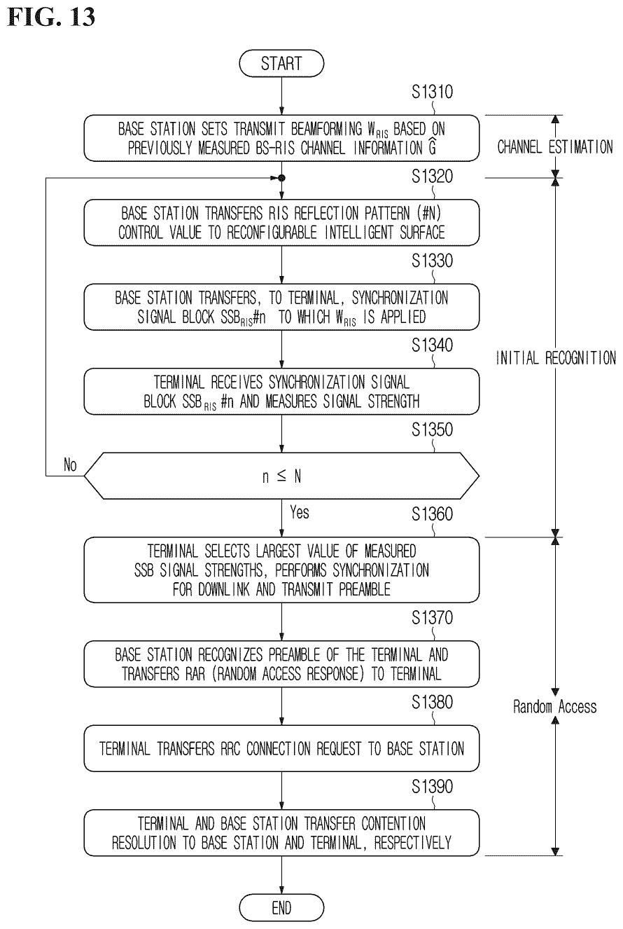

At this time, if the IRS control value Φ is determined, wₖ may be determined by calculation. Here, the Alternating Optimization (AO) algorithm for solving the above-described optimization problem may be used. For example, the AO algorithm may be a method of determining a trust region for each IRS element using channel information (h_{d}, hᵣ, G), and may be as shown in FIG. 13. In addition, a binary decision is repeatedly performed until an objective value converges, thereby obtaining θₙ. Here, the upper bound of the convergence value may be βₙ(θₙ)=1 in the case of an ideal IRS. At this time, as an example, in FIG. 12, the IRS may repeat the above-described operation to find an optimized value for each IRS element described above.

Here, the AO algorithm needs to be repeated until convergence. In addition, since each optimization value must be derived for each IRS element, the complexity increases and the amount of computation may increase. At this time, the complexity and the amount of computation may increase depending on the number of antennas M of the base station and the number of IRS elements N, and there may be a limit to calculating this. In addition, when optimizing the AO algorithm, the measurement values of all channels including the IRS may be required, and considering the above, there may be a limit to optimization.

Wireless communication technology tries to approach Shannon's channel capacity limit by controlling transceivers optimized for the environment, as described above. However, in poor NLOS environments such as shadow areas, transmission and reception may be almost impossible due to channel capacity limit. For example, although the channel environment can be improved by power increase of the transmitter and MIMO technology, there may be a limit to channel environments with high signal loss. In particular, in the 6G terahertz environment, the signal loss may be greater due to the use of high frequency bands. Since it is difficult for multipaths to exist in the 6G terahertz environment, it may be difficult to overcome Shannon's channel capacity limit by optimizing the transceiver.

Therefore, in order to provide a new wireless communication system (e.g., 6G service (MBRLLC, mURLLC, HCS, 3CLS), a technology may be required to optimize the communication environment to suit the service. For example, a relay may be used to increase the coverage of a base station cell and support shadow areas. Although a relay may expand cell coverage and partially cover shadow areas, it may additionally generate interference signals for other users. Therefore, communication utilizing a relay may also have limitations in the overall communication resource efficiency. As another example, a relay may require high additional cost and energy, and a lot of effort may be required to manage complex and mixed interference signals.

Considering the above-described points, a method of controlling the radio channel environment using a reconfigurable intelligent surface (RIS) rather than a relay may be required, which will be described below. In addition, a method of overcoming Shannon's channel capacity limit may be presented in a smart radio environment that optimizes transceivers through the RIS, and a technique for outdoor to indoor (O2I) communication based on the RIS will be described below.

In addition, as an example, there is a need to consider multi-user access in RIS-based communication. That is, even when RIS-based communication is performed, a method for multiple users to perform communication may be required. Specifically, hereinafter, a method of supporting multi-user access rather than single-user access of a RIS and enabling initial access of a terminal through the RIS in a shadow area where communication is impossible will be described. As an example, a method of supporting multiple access through a RIS in an orthogonal multiple access method (e.g., FDMA, TDMA) and improving problems that arise therefrom through artificial intelligence will be described. In addition, as an example, a method of enabling communication in a shadow area where communication is impossible by considering a RIS during initial recognition of a terminal or a random access process will be described.

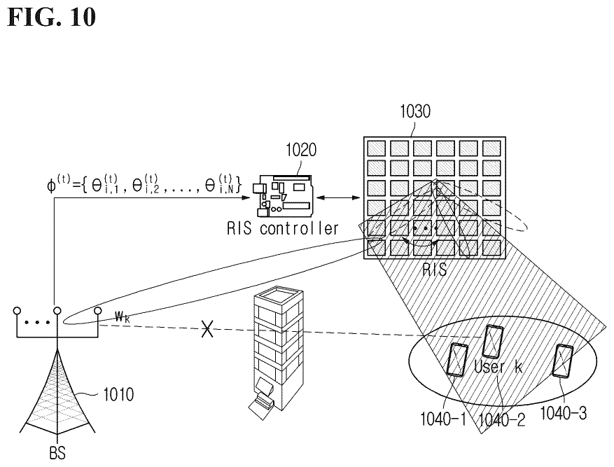

For example, FIG. 10 is a diagram illustrating a shadow-area wireless communication environment that enables multi-use access using a RIS, which is applicable to an embodiment of the present disclosure. Referring to FIG. 10, a channel G between a base station 1010 and a RIS 1030 may be a channel without location change in a Line of Sight (LoS) environment. The base station 1010 may recognize and manage transmit beamforming W_{RIS} for the channel G. Here, at least one terminal 1040-1, 1040-2, 1040-3 may be located in a shadow area. Therefore, at least one terminal 1040-1, 1040-2, 1040-3 may be in a state where initial recognition or random access is impossible, and there is a need to attempt to access the base station 1010 through the RIS 1030. For example, the base station 1010 may perform beam-based communication with the terminal through beam sweeping based on beam management operation. Here, at least one terminal 1040-1, 1040-2, 1040-3 is located in a shaded area and needs to access the base station 1010 through the RIS 1030. Therefore, RIS beam sweeping may be considered in addition to beam sweeping.

At this time, in the RIS initial recognition mode, control may be performed such that a reference signal is transferred through transmit beamforming W_{RIS} of the preset RIS 1030, and RIS beam sweeping is individually implemented through the control value of the RIS 1030 or beam sweeping is performed automatically based on a certain period of time. For example, the base station 1010 may sequentially or simultaneously transmit the reference signal to multiple RISs 1030 managed by the base station 1010 based on the RIS initial recognition mode.

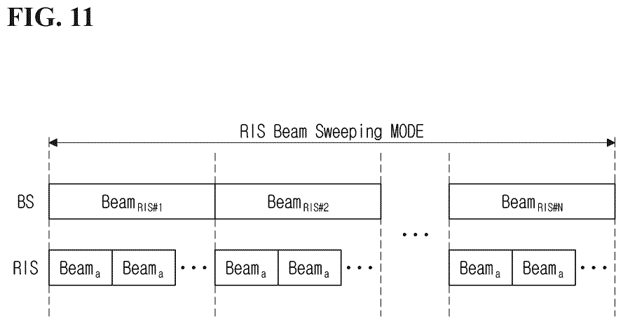

As a specific example, FIG. 11 is a diagram showing a RIS initial recognition mode, which is applicable to the present disclosure. Referring to FIG. 11, a base station may transfer a reference signal through transmit beamforming W_{RIS} of a preset RIS based on the RIS initial recognition mode to at least one RIS managed by the base station. Here, each RIS may transmit a reference signal received from the base station to at least one terminal located in a shadow area through RIS beam sweeping. That is, the RIS may also perform RIS beam sweeping. At this time, as an example, the RIS may include a RIS controller, and the RIS controller may perform RIS beam sweeping based on the transmit beamforming W_{RIS} received from the base station.

In addition, as an example, FIGS. 12 and 13 are diagrams showing a signal flow between a base station, a terminal, and a RIS for initial connection of the terminal in a wireless communication environment, which is applicable to the present disclosure. Referring to FIGS. 12 and 13, the base station 1210 may recognize and manage the transmit beamforming W_{RIS} for a channel G. As a specific example, at step S1310, the base station 1210 may check the transmit beamforming W_{RIS} for the channel G between the base station 1210 and the RIS 1220 based on the initial installation of the RIS 1220 or a preset cycle, and thus recognize W_{RIS} in advance. As an example, W_{RIS} may be measured by a measuring device when the RIS 1220 is initially installed, or may be periodically measured by a device (drone) capable of mobility or a low-power/low-cost sensor. In addition, the base station 1210 may be synchronized with the RIS 1220, and is not limited to a specific embodiment.

After that, at step S1320, the base station 1210 may transfer control value information for setting the reflection pattern of the RIS 1220 to the RIS 1220. As an example, the RIS 1220 may set reflection pattern #1 based on the control value received from the base station 1210. Thereafter, at step S1330, the RIS 1220 may receive a synchronization signal block (SSB) (Transmit Beamforming) SSB_{RIS} to which transmit beamforming W_{RIS} is applied from the base station 1210. Thereafter, at step S1340, the RIS 1220 may transmit SSB_{RIS} #1 to the terminal 1230 through the set reflection pattern #1, and the terminal 1230 may measure a signal strength. Thereafter, at step S1350, the base station 1210 may measure the signal strength for SSB_{RIS} #1 to SSB_{RIS} #n based on each reflection pattern. As an example, each reflection pattern for the RIS 1220 may be a beam sweeping form in the RIS 1220 and may be RIS beam sweeping. As an example, the beam sweeping may be implemented based on the beam sweeping form between the base station and the terminal, or another basic pattern may be applied, and is not limited to a specific embodiment.

Here, at step S1360, the terminal 1230 may perform synchronization for the downlink based on SSB_{RIS} with the largest received signal and transmit a preamble in the reception step of the predefined periodic RIS sweeping mode according to the corresponding time interval.

As a specific example, each preamble associated with SSB_{RIS} may be present, and a preamble transmission occasion may be preset. That is, a preamble corresponding to each synchronization signal may be set for SSB_{RIS} #1 to SSB_{RIS} #n based on the reflection pattern, and time information (or occasion) for transmitting the corresponding preamble may be preset. Accordingly, the terminal 1230 may identify SSB_{RIS} with the largest received signal, and transmit the preamble corresponding to the one in the corresponding time interval (or occasion), but is not limited to a specific embodiment. Here, the terminal 1230 may obtain relationship information about the preamble and SSB_{RIS} in advance based on the RIS 1220. As another example, the terminal 1230 may obtain relationship information about the preamble and SSB_{RIS} from the base station 1010, but is not limited to a specific embodiment.

If the terminal 1230 transmits a preamble signal to the base station 1210 in the receiving step of the periodic RIS Sweeping mode, the base station 1210 may perform uplink synchronization through the preamble. Thereafter, at step S1370, the base station 1210 may transfer a random access response (RAR) to the terminal 1230. Here, the RAR may be transferred from the base station 1210 to the terminal 1230 through the RIS 1220 through the reflection pattern of SSB_{RIS} with the largest signal strength based on the transmit beamforming W_{RIS} of the RIS. Thereafter, at step S1380, the terminal 1230 may transmit an RRC connection request to the base station 1210. Thereafter, at step S1390, the base station 1210 may receive contention resolution and complete random access. That is, the terminal 1230 may transmit a corresponding preamble based on the transmit beamforming of the RIS and the RIS beam sweeping mode, and perform initial access through this. When the initial access of the terminal is completed, the base station needs to recognize the terminal connected to the corresponding RIS and the terminal number information, and RIS resource allocation may be performed based on this.

For example, the channel estimation step may use transmit beamforming based on previously measured BS-RIS channel information Ĝ or may directly add a channel measurement method in various ways, as described above. In particular, when an active sensor is present in the RIS, channel estimation may be easy through a reference signal of the base station. At this time, the transmit beamforming value of the base station may be fixed as W_{RIS} and W_{RIS} may be different for each RIS. At this time, as an example, the base station transmit beamforming W_{RIS} for a maximum transmit rate (MRX) may be as shown in Equation 7 below.

$${w}_{RIS}^{*} = \sqrt{{P}_{max}} \frac{{G}^{H}}{‖ G ‖} \qquad [ Equation 7 ]$$

Pₘₐₓ: Transmit power at the AP

In addition, as an example, the RIS for multi-user access may consider orthogonal multiple access and non-orthogonal multiple access (NOMA).

For multi-user access, the RIS may be largely divided into orthogonal multiple access and non-orthogonal multiple access (NOMA). Here, the non-orthogonal multiple access may have an advantage in channel capacity over the orthogonal multiple access. However, the non-orthogonal multiple access may additionally require a successive interference cancellation (SIC) decoder at the terminal, which may result in restrictions.

Considering the above, a method of performing multiple access in an orthogonal multiple access manner based on the RIS may be necessary, but may not be limited thereto.

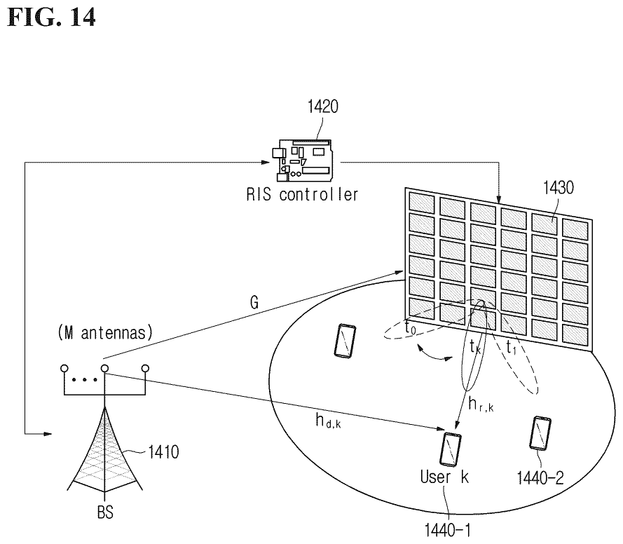

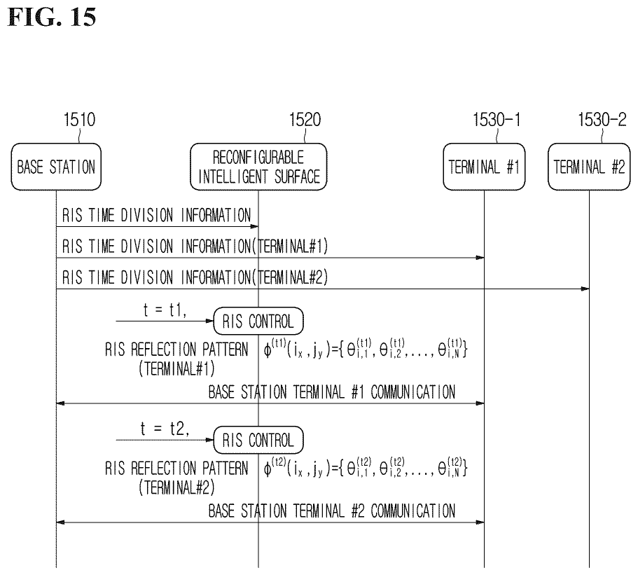

FIG. 14 and FIG. 15 are diagrams illustrating a method of supporting multi-user access through a RIS based on orthogonal multiple access applicable to the present disclosure. For example, signal modeling for multi-user access through the RIS 1430 may be as shown in Equation 8 below, and may be in a form that considers two users 1440-1 and 1440-2, but may not be limited thereto. At this time, if it is re-expressed in the form of an orthogonal channel

$${q}_{k}^{H} {=}^{Δ} {g}_{k}^{H} diag ( {h}_{r} )$$

in Equation 8, it may be as shown in Equation 9, and an objective function for RIS optimization in terms of minimum transmit power may be as shown in Equations 10 and 11 below. Here, referring to FIG. 14, γ₁, γ₂ are target rates of two users 1440-1 and 1440-2, and may be

$${λ}_{1} ( θ ) = {\vert {q}_{1}^{H} θ + {h}_{d 1} \vert}^{2} , {λ}_{2} ( θ ) = {\vert {q}_{2}^{H} θ + {h}_{d 2} \vert}^{2} .$$

In addition, as an example, in TDMA, a target rate may be achieved with less transmit power than FDMA because separate optimal values θ₁ and θ₂ may be applied according to time (user). Therefore, although TDMA is advantageous in terms of channel capacity, additional signaling may be required to handle temporal division for each user.

$${y}_{k} = ( {g}_{k}^{H} θ {h}_{r} + {h}_{d , k} ) ( √ \overline{{P}_{1}} {s}_{1} + √ \overline{{P}_{2}} {s}_{2} ) + {n}_{k} , k ∈ \{ 1 , 2 \} \qquad [ Equation 8 ]$$

$${y}_{k} = ( {g}_{k}^{H} θ + {h}_{d , k} ) ( √ \overline{{P}_{1}} {s}_{1} + √ \overline{{P}_{2}} {s}_{2} ) + {n}_{k} , k ∈ \{ 1 , 2 \} \qquad [ Equation 9 ]$$

$$FDMA minimum transmit power {P}_{P} {=}^{Δ} {min}_{θ} \frac{( {2}^{2 {γ}_{1}} - 1 )}{2 {λ}_{1} ( θ )} + \frac{( {2}^{{2}_{{γ}_{2}}} - 1 )}{2 {λ}_{2} ( θ )} \qquad [ Equation 10 ]$$

$$TDMA minimum transmit power {P}_{T} {=}^{Δ} {min}_{{θ}_{1}} \frac{( {2}^{2 {γ}_{1}} - 1 )}{2 {λ}_{1} ( {θ}_{1} )} + {min}_{{θ}_{2}} \frac{( {2}^{2 {γ}_{2}} - 1 )}{2 {λ}_{2} ( {θ}_{2} )} \qquad [ Equation 11 ]$$

Based on the above, referring to FIG. 14, the RIS 1430 may generate beams for each terminal in time, thereby supporting communication between the base station 1410 and the terminals 1440-1 and 1440-2.

Specifically, referring to FIG. 15, a base station 1510 may perform communication with a terminal through a time division multiple access (TDMA) method via a RIS 1520. The base station 1510 may recognize information about how many terminals are connected to the corresponding RIS 1520 and which terminals are connected through the initial recognition step of terminals 1530-1 and 1530-2. Based on the above-described information, the base station 1510 may transfer time division information to the RIS 1520. Additionally, the base station 1510 may transfer RIS time division information to each of the terminals 1530-1 and 1530-2.

As a specific example, the base station 1510 may transfer RIS time division information corresponding to each of the terminal 1530-1 and 1530-2 during the initial recognition process with each of the terminals 1530-1 and 1530-2.

As another example, the base station 1510 may recognize information about how many terminals are connected to the corresponding RIS 1520 and which terminal is connected in the initial recognition step, and based on this, determine RIS time division information of each of the terminals 1530-1 and 1530-2 connected to the corresponding RIS 1520. That is, the RIS time division information of each terminal may be determined by the base station 1510 and transferred to each terminal, and is not limited to a specific embodiment.

Thereafter, terminal #1 1530-1 and terminal #2 1530-2 may obtain time division information of each from the base station 1510. Thereafter, the RIS 1520 may control the RIS 1520 based on the corresponding time division information to perform communication. For example, the RIS 1520 may set a beam pattern for terminal #1 1530-1 at the time (t=t1). At this time, the base station 1510 may perform communication with terminal #1 1530-1 through the RIS 1520. Thereafter, the RIS 1520 may set a beam pattern for terminal #2 1530-2 at the time (t=t2) for terminal #2 1530-2. The base station 1510 may communicate with terminal #2 1530-2 through the RIS 1520. Here, as an example, the time division information may have a certain cycle. As another example, the time division information may include initial starting point and cycle information of each terminal. Through this, each of the terminals 1530-1 and 1530-2 may communicate with the base station 1510 in a preset interval.

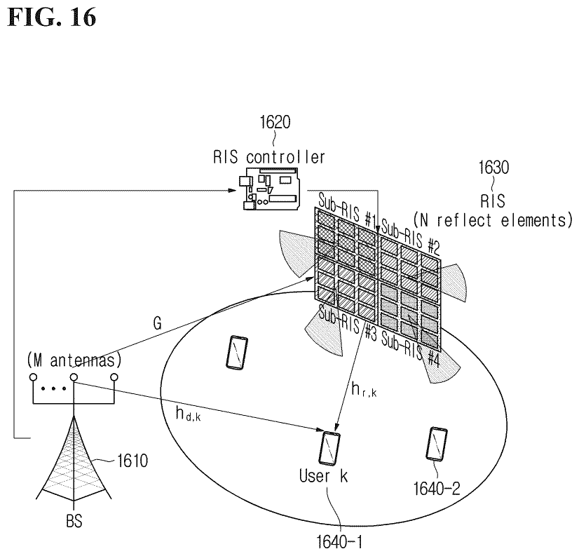

FIG. 16 is a diagram illustrating a method of supporting multiple access through a RIS in a frequency division multiple access (FDMA) method applicable to the present disclosure. Referring to FIG. 16, the RIS 1630 may generate a beam for a terminal in each sub RIS through a sub-array RIS to support communication between a base station and a terminal. For example, in FIG. 16, sub RIS #3 may generate a beam toward terminal #1 1640-1 to support communication between terminal #1 1640-1 and the base station 1610. In addition, sub RIS #4 may generate a beam toward terminal #2 1640-2 to support communication between terminal #2 16420 and the base station 1610. That is, the RIS includes a plurality of sub-array RISs and may support multi-user access based on the same.

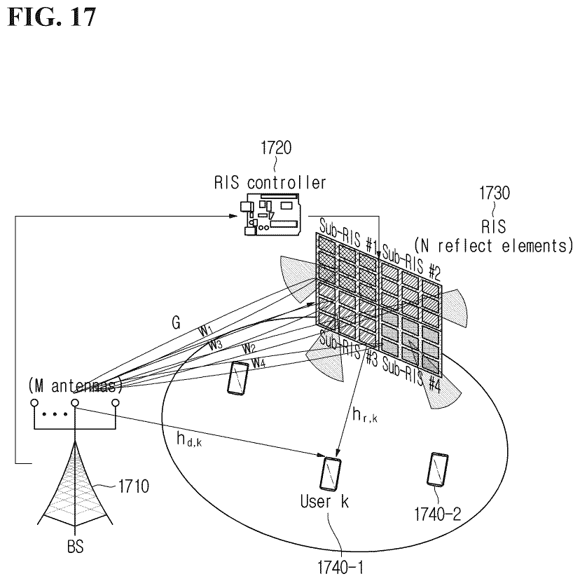

FIG. 17 is a diagram illustrating a method of supporting multiple access by considering a channel environment in an environment where a base station and a sub RIS are spatially separated, which is applicable to the present disclosure. Referring to FIG. 17, a base station 1710 and sub-RISs may form spatially separated channel environments. For example, the base station 1710 may form a transmit beamforming W₁-W₄ to each sub RIS within the RIS 1730. Here, when the distance between the base station 1710 and the RIS 1730 is close, beam interference may not occur between the transmit beamforming W₁-W₄ transmitted from the base station 1710 to each sub RIS 1730. Here, since each of the terminals 1740-1 and 1740-2 is spatially separated from the base station 1710, the FDMA method may not be mandatory, but is not limited to a specific embodiment.

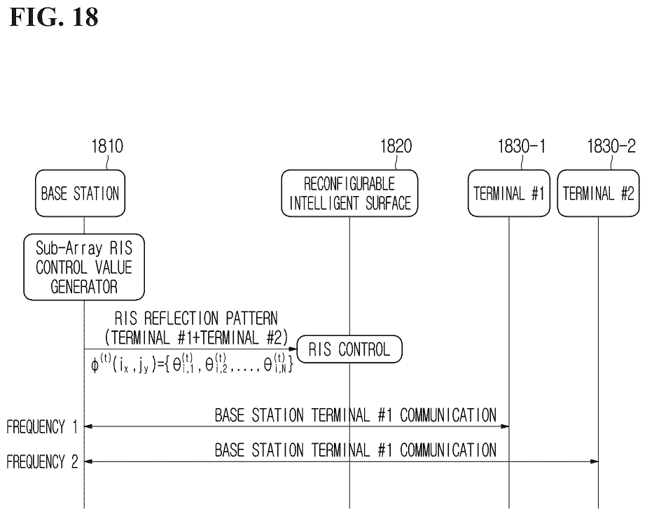

As a specific example, FIG. 18 is a diagram illustrating a method of supporting multi-user access via a RIS based on an FDMA method applicable to the present disclosure. Referring to FIG. 18, a base station 1810 may generate a sub-array RIS control value. As an example, the base station 1810 may include a sub RIS control value generator, but may not be limited thereto. The base station 1810 may generate a sub-array RIS control value based on information obtained in an initial recognition step of a terminal, and may generate a RIS reflection pattern value based thereon. That is, the RIS reflection pattern value may include a sub RIS reflection pattern value for each terminal so that the terminals associated with the corresponding RIS may perform communication via the sub RIS. At this time, the base station 1810 may transfer the RIS reflection pattern value to the RIS 1820. Here, the RIS 1820 may determine a reflection pattern value for each sub RIS based on the received RIS reflection pattern value to control a beam direction. Thereafter, the base station 1810 may perform communication with each terminal corresponding to the sub RIS through each frequency. As a specific example, referring to FIG. 18, terminal #1 1830-1 may be a terminal corresponding to sub RIS #1, and terminal #2 1830-2 may be a terminal corresponding to sub RIS #2. Here, the RIS 1820 may control the beam direction of sub RIS #1 to be directed toward terminal #1 1830-1 based on the reflection pattern value received from the base station 1810, and may control the beam direction of sub-RIS #2 to be directed toward terminal #2 1830-2 based on the received reflection pattern value. Thereafter, the base station 1810 may transmit beamforming to sub-RIS #1 at frequency 1, and the corresponding beam may be transferred to terminal #1 1830-1 to perform communication. Additionally, the base station 1810 may transmit beamforming W₂ to sub-RIS #2 at frequency 2, and the beam may be transferred to terminal #2 1830-2 to perform communication.

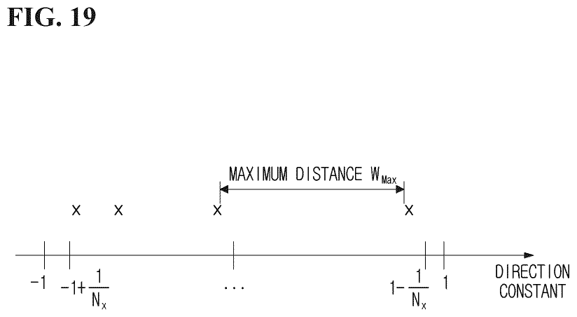

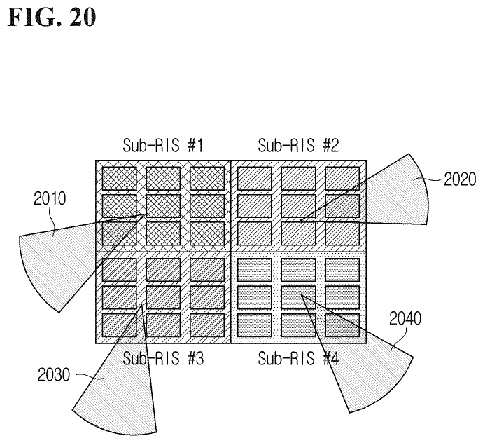

FIGS. 19 and 20 are diagrams illustrating a method of generating a sub-array RIS control value, which is applicable to the present disclosure. Referring to FIG. 19, the sub-array control value may be generated based on the channel information of the terminals included in the RIS after the initial recognition and random access of the terminal. Here, the control value may be set by considering not only the sub-array allocation of the RIS for the terminals but also the beam interference that may occur due to the increased beam width caused by the sub-array. For example, an optimal value may be generated by using a method that uses an algorithm that sets the control value by considering the beam interference and a method that utilizes artificial intelligence.

As a specific example, referring to FIG. 19, terminals based on the steering of the RIS may be marked with an X. The above-described information may be obtained based on the initial recognition of the terminal or the reference signal sent from the base station. Nₓ is the number of elements of the reconfigurable intelligent surface in the x-axis direction, and the angle of the reconfigurable intelligent surface may be expressed by constantizing −90° to −1 and 90° to 1. When the direction of the beam is expressed as an interval of

$$\frac{180 °}{{N}_{x}} ,$$

the directionality may be expressed by constantizing it to

$${a}_{x} ( i ) = - 1 + \frac{2 i - 1}{{N}_{x}} ,$$

i∈1, 2, 3, . . . , Nₓ, However, this is only one example and may not be limited to the above-described embodiment. Here, when the beam direction is expressed as an interval of

$$\frac{180 °}{{N}_{x}} ,$$

the directionality may be expressed by constantizing it to

$${a}_{x} ( i ) = - 1 + \frac{2 i - 1}{{N}_{x}} ,$$

i∈{1, 2, 3, . . . , Nₓ}. In addition, the beam width may also be expressed as an interval of

$$\frac{180 °}{{N}_{x}} ,$$

At this time, if Nₓ is 4, the directional interval becomes 45° and aₓ(0), aₓ(1), aₓ(2), and aₓ(3) represent −67.5°, −22.5°, 22.5°, and 67.5°, respectively, and the beam width may also be 45°

$$\frac{180 °}{( = {N}_{x} )} .$$

In addition, the maximum distance of the mark (X) from the terminal based on the steering may be defined as W_{MAX} and since beam interference occurs when the beam width exceeds W_{MAX}, W_{MAX} may be the upper bound limit of the beam width.

In addition, the frequency ratio R may be as shown in Equation 12 below.

$$R = \frac{{Count}_{j}}{{Count}_{total}} \qquad [ Equation 12 ]$$

Here, the frequency rate R may be expressed as the count Countⱼ of the direction index j is measured relative to the total count Countₜₒₜₐₗ of measurements. Rᵤₚₚₑᵣ and R_{low} may represent an upper bound limit and a lower bound limit of the frequency rate R. For example, a frequency rate value lower than or equal to the lower bound limit among the frequency rate R values may be ignored. In addition, a maximum distance W_{Max} may be measured for a direction constant having a frequency rate higher than or equal to the upper bound limit among the frequency rate R values. For example, since beam interference occurs when the beam width exceeds W_{Max}, W_{Max} may be the upper bound value of the beam width. At this time, based on the above description, multiple beams 2010, 2020, 2030 and 2040 of the meta-lens may be set in a sub-array form as shown in FIG. 20. Here, when the meta-lens is composed of M sub-arrays, the beam width may be as shown in Equation 13 below.

$$Beam Width = \frac{2 M}{{N}_{x}} \qquad [ Equation 13 ]$$

At this time, if the number M of sub-arrays increases, the beam width may increase. However, if the beam width increases and overlaps, interference may occur. Here, since the maximum distance W_{Max} is the upper bound limit of the beam width for a directional constant with a frequency rate, the upper bound limit of the number M of sub-arrays may be as shown in Equation 14 below.

$${W}_{Beam} \leq {W}_{Max} ⇒ M \leq \frac{{W}_{Max} {N}_{x}}{2} \qquad [ Equation 14 ]$$

For example, when the M value increases, the beamforming gain may decrease, and the size of the signal received at the terminal may also decrease. In other words, when the number of sub-arrays increases, the signal received at the terminal may decrease.

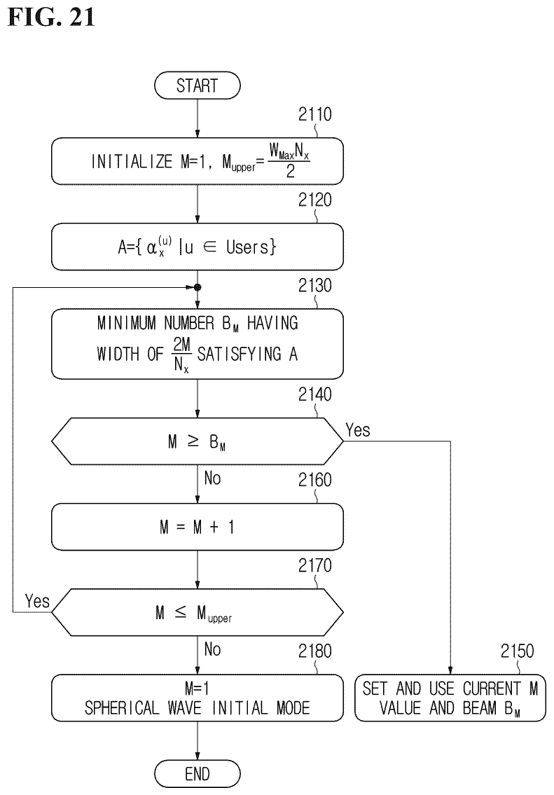

Here, FIG. 21 is a flowchart illustrating a method of setting an initial recognition mode based on a frequency rate according to an embodiment of the present disclosure. Referring to FIG. 21, the number of sub-arrays and the beams used in the initial recognition mode may be set according to the frequency rate. For example, at step S2110, the number of sub-arrays M may be initialized to 1, and the upper bound limit may be set as in Equation 15 below.

$${M}_{upper} = \frac{{W}_{Max} {N}_{X}}{2} \qquad [ Equation 15 ]$$

At this time, at step S2120, a set A of a directional constant aₓ(i) with a frequency rate greater than Rᵤₚₚₑᵣ may be set. After that, at step S2130, while increasing M, the minimum number of beams B_{M} having a width of

$$\frac{2 M}{{N}_{x}}$$

satisfying A may be obtained. That is, the minimum number of beams may be obtained while increasing the number of sub-arrays. At this time, at step S2140, if the number of sub-arrays M is greater than or equal to the minimum number of required beams B_{M}, at step S2150, the M value and beams B_{M} may be set. The initial recognition mode of the meta-lens may be set according to the number M of sub-arrays and the beams B_{M} On the other hand, at step S2160, if M is smaller than B_{M} while increasing M, the M value may be increased. At this time, the M value is the maximum number of sub-arrays and may be made not to exceed the upper bound limit value Mᵤₚₚₑᵣ. That is, at step S2170, if M is smaller than Mᵤₚₚₑᵣ, it may be checked whether the increased M is larger than 1, as described above. On the other hand, at step S2180, if the beam is not found until M becomes Mᵤₚₚₑᵣ, M may be set to 1. That is, in the initial recognition mode, the sub-array may be set to use a uniform spherical wave in the omnidirectional direction, and the initial recognition mode may be set based on the above.

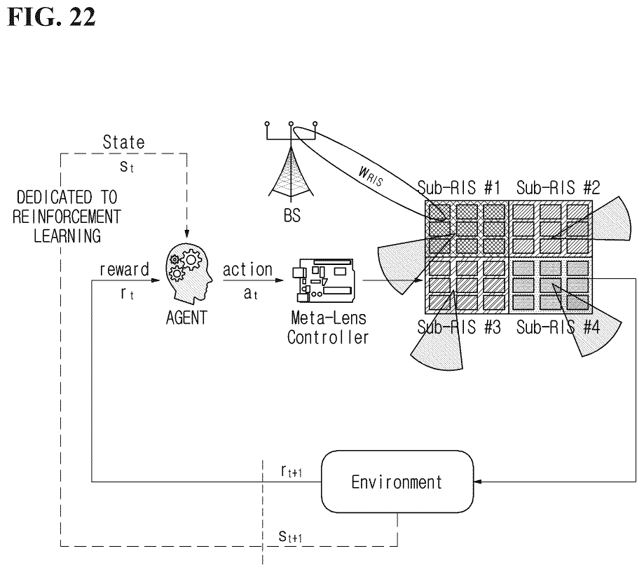

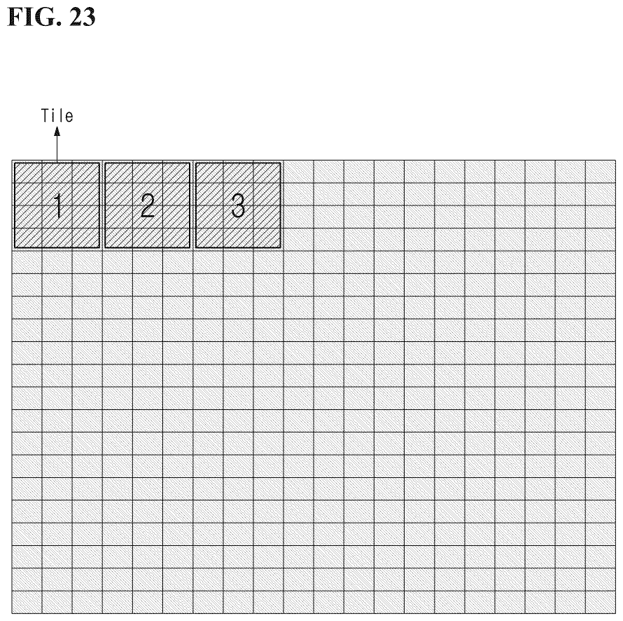

Also, as an example, FIG. 22 and FIG. 23 are diagrams illustrating a method of generating a sub-array RIS value considering beam interference based on artificial intelligence. Artificial intelligence may increase performance by learning in various channel environments through transfer learning and applying the model to actual implementation to relearn it.

Referring to FIG. 22, it may be a RIS control value generator based on reinforcement learning. Here, a state and a reward are used as inputs, and an agent may select an action as output. At this time, the state is not used in MAB. An action may be selected as a RIS control value to enable the terminal to select an optimal transmit beamforming value. A RIS control value generator based on reinforcement learning may obtain a reward for an action and changed state information from the environment, use them for learning, and then repeat the process of selecting an action again.

FIG. 23 shows the tile structure of the RIS control value generator. Here, a tile may be used by grouping a plurality of adjacent RIS elements, thereby increasing RIS efficiency. For example, an action may be a set of setting values of tiles of the RIS. In addition, the setting values of the tiles may be selecting an index of a codebook indicating a direction vector. For example, what is selected in artificial intelligence may be an index of an azimuth and an elevation of a direction vector, and may be as shown in Equation 16 below.

$$\begin{matrix}{a}_{t} = ( {Tile}_{t}^{( 1 )} , {Tile}_{t}^{( 2 )} , {Tile}_{t}^{( C )} ) = ( \text{?} ( {i}_{x} , {j}_{y} ) , \text{?} ( {i}_{x} , {j}_{y} ) , … , \text{?} ( {i}_{x} , {j}_{y} ) ) \\ {i}_{λ} ∈ \{ 1 , 2 , 3 , … , {J}_{x} \} , {j}_{y} ∈ \{ 1 , 2 , 3 , … , {J}_{y} \}\end{matrix} \qquad [ Equation 16 ]$$

In addition, the state is a factor received from the environment and may be a state variable that is initially set using initial recognition or channel state information by the reference signal. Here, the control value set in the action may be transferred to the next state through artificial intelligence. The reward is a value measured by the terminal and may be a result of the control value selected by the RIS. The reward may be transferred from the terminal to the location where the RIS control value generator is implemented (e.g., terminal, base station, RIS). For example, the reward may be a processed value from the terminal. Here, the reward may be implemented by adding a RIS performance measuring device to the terminal and applying a weight, and the reward may be as shown in Equation 17 below when the RIS performance measuring device is not passed through.

$$\begin{matrix}reward of each user & {r}_{t}^{( user )} = SNR or {f}_{MSE} or CQ 1 \\ total reward & {r}_{t} = \frac{1}{U} {\sum }_{u = 1}^{U} {r}_{t}^{( u )}\end{matrix} \qquad [ Equation 17 ]$$

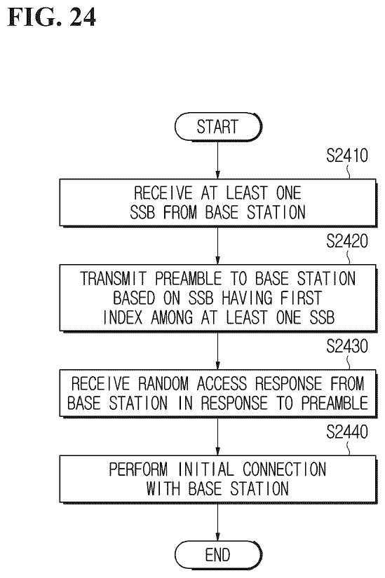

FIG. 24 is a flowchart illustrating terminal operation according to an embodiment.

Referring to FIG. 24, at step S2410, a terminal may receive at least one synchronization signal block (SSB) from a base station. Here, the terminal may receive at least one SSB transmitted through a RIS. For example, transmit beamforming between the base station and the RIS may be preset, and the base station may transmit the SSB to the RIS based on the preset transmit beamforming. Thereafter, the RIS may change the reflection pattern to transmit at least one SSB in each beam direction. Here, SSBs having different indices may be transmitted in different directions. That is, the RIS may change the reflection pattern to transmit at least one SSB in different directions. For example, the SSB may be a RIS-associated SSB. In this case, for example, each of the SSBs having different indices may correspond to a different preamble and time interval. That is, there may be a preamble and a time interval (or occasion) corresponding to each SSB. At this time, the terminal may select an SSB having a first index among at least one SSB. For example, the terminal may measure signal strengths of at least one SSB and select an SSB having the largest measured signal strength. Thereafter, at step S2420, the terminal may transmit a preamble to the base station based on the SSB having the first index among the at least one SSB. Thereafter, at step S2430, the terminal may receive a random access response from the base station in response to the preamble. Moreover, at step S2440, the terminal may perform an initial connection with the base station. Thereafter, the RIS may set a beam with a first reflection pattern corresponding to the SSB having the first index described above, and may transfer a signal received from the base station through preset transmit beamforming to the terminal. Here, as an example, the number of terminals associated with the RIS and identification information of the terminals may be transferred to the base station based on the initial connection. That is, the base station may check which terminals are connected to the RIS and information on the number of connected terminals through the initial connection.

Here, as an example, terminals associated with the RIS may communicate with the base station through the RIS based on a non-orthogonal multiple access (NOMA), and thus, channel capacity can be increased.

As another example, terminals associated with the RIS may communicate with the base station through the RIS based on an orthogonal multiple access. At this time, as an example, each of the terminals associated with the RIS may communicate with the base station through a time division multiple access based on the RIS. At this time, the base station may generate RIS time division information based on the initial connection. As an example, the base station may generate RIS time division information based on terminal identification information and terminal number information. Thereafter, the RIS time division information may be transferred from the base station to the RIS. In addition, each of the terminals associated with the RIS may obtain RIS time division information of each of the terminals associated with the RIS from the base station. At this time, the RIS may transfer a signal received from the base station in a time interval corresponding to each of the terminals associated with the RIS based on the RIS time division information, as described above.

As another example, each of the terminals associated with the RIS may perform communication with the base station through frequency division multiple access based on the RIS. Here, the RIS generates a beam through each of the sub-array RISs, and the base station and the terminals associated with the RIS may perform communication based on the beam generated from each of the sub-array RISs. More specifically, the base station may transfer a signal based on first transmit beamforming to a first sub-array RIS among the sub-array RISs in the RIS, and transfer a signal to a first terminal among the terminals associated with the RIS through the beam formed based on the first sub-array RIS. In addition, the base station may transfer a signal based on second transmit beamforming to a second sub-array RIS among the sub-array RISs in the RIS, and transfer a signal to a second terminal among the terminals associated with the RIS through the beam formed based on the second sub-array RIS. Here, the first terminal may perform communication with the base station based on the first sub-array RIS through the first frequency, and the second terminal may perform communication with the base station based on the second sub-array RIS through the second frequency, as described above.

As another example, the sub-array RIS control value may be generated by the base station according to channel information of each of the terminals associated with the RIS based on the initial connection. The sub-array RIS control value may be transferred to the RIS. Here, an initial recognition mode may be determined based on the number of sub-arrays in the RIS and the minimum number of beams. Here, the initial recognition mode may be determined according to the number of sub-arrays and the minimum number of beams that satisfy a frequency rate direction constant derived based on the frequency rate learning information of the terminal direction. In addition, if there is no combination of the number of sub-arrays and the minimum number of beams that satisfy the frequency rate direction constant, the number of sub-arrays may be set to 1. In addition, if the number of sub-arrays is 1, the RIS may generate a fixed spherical wave. Here, at least one of the reward information or the channel state information may be acquired, and the sub-array RIS control value may be generated through at least one of the reward information and the channel state information, as described above.

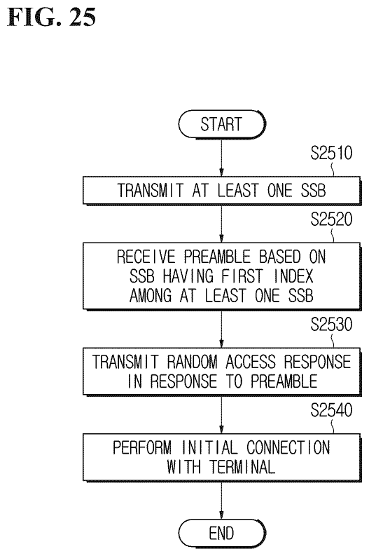

FIG. 25 is a flowchart illustrating base station operation according to an embodiment.

Referring to FIG. 25, at step S2510, a base station may transmit at least one SSB. Here, the base station may transmit at least one SSB to a terminal through a RIS. For example, transmit beamforming between the base station and the RIS may be preset, and the base station may transmit the SSB to the RIS based on the preset transmit beamforming. Thereafter, the RIS may change the reflection pattern to transmit at least one SSB in each beam direction. Here, SSBs having different indices may be transmitted in different directions. That is, the RIS may change the reflection pattern to transmit at least one SSB in different directions. For example, the SSB may be a RIS-associated SSB. In this case, for example, each of the SSBs having different indices may correspond to a different preamble and time interval. That is, there may be a preamble and a time interval (or occasion) corresponding to each SSB. At this time, the terminal may select an SSB having a first index among at least one SSB. For example, the terminal may measure signal strengths of at least one SSB and select an SSB having a largest measured signal strength. Thereafter, the terminal may transmit a preamble to the base station based on the SSB having the first index among the at least one SSB. That is, at step S2520, the base station may receive the preamble based on the SSB having the first index among the at least one SSB. Thereafter, at step S2530, the base station may transmit a random access response to the terminal in response to the preamble. Moreover, at step S2540, the base station may perform an initial connection with the terminal. Thereafter, the RIS may set a beam with a first reflection pattern corresponding to the SSB having the first index described above, and may transfer a signal received from the base station through preset transmit beamforming to the terminal. Here, as an example, the number of terminals associated with the RIS and identification information of the terminals may be transferred to the base station based on the initial connection. That is, the base station may check which terminals are connected to the RIS and information on the number of connected terminals through the initial connection.

Here, as an example, terminals associated with the RIS may communicate with the base station through the RIS based on a non-orthogonal multiple access (NOMA), and thus, channel capacity can be increased.

As another example, terminals associated with the RIS may communicate with the base station through the RIS based on an orthogonal multiple access. At this time, as an example, each of the terminals associated with the RIS may communicate with the base station through a time division multiple access based on the RIS. At this time, the base station may generate RIS time division information based on the initial connection. As an example, the base station may generate RIS time division information based on terminal identification information and terminal number information. Thereafter, the RIS time division information may be transferred from the base station to the RIS. In addition, each of the terminals associated with the RIS may obtain RIS time division information of each of the terminals associated with the RIS from the base station. At this time, the RIS may transfer a signal received from the base station in a time interval corresponding to each of the terminals associated with the RIS based on the RIS time division information, as described above.

As another example, each of the terminals associated with the RIS may perform communication with the base station through frequency division multiple access based on the RIS. Here, the RIS generates a beam through each of the sub-array RISs, and the base station and the terminals associated with the RIS may perform communication based on the beam generated from each of the sub-array RISs. More specifically, the base station may transfer a signal based on first transmit beamforming to a first sub-array RIS among the sub-array RISs in the RIS, and transfer a signal to a first terminal among the terminals associated with the RIS through the beam formed based on the first sub-array RIS. In addition, the base station may transfer a signal based on second transmit beamforming to a second sub-array RIS among the sub-array RISs in the RIS, and transfer a signal to a second terminal among the terminals associated with the RIS through the beam formed based on the second sub-array RIS. Here, the first terminal may perform communication with the base station based on the first sub-array RIS through the first frequency, and the second terminal may perform communication with the base station based on the second sub-array RIS through the second frequency, as described above.

As another example, the sub-array RIS control value may be generated by the base station according to channel information of each of the terminals associated with the RIS based on the initial connection. The sub-array RIS control value may be transferred to the RIS. Here, an initial recognition mode may be determined based on the number of sub-arrays in the RIS and the minimum number of beams. Here, the initial recognition mode may be determined according to the number of sub-arrays and the minimum number of beams that satisfy a frequency rate direction constant derived based on the frequency rate learning information of the terminal direction. In addition, if there is no combination of the number of sub-arrays and the minimum number of beams that satisfy the frequency rate direction constant, the number of sub-arrays may be set to 1. In addition, if the number of sub-arrays is 1, the RIS may generate a fixed spherical wave. Here, at least one of the reward information or the channel state information may be acquired, and the sub-array RIS control value may be generated through at least one of the reward information and the channel state information, as described above.

As the examples of the proposal method described above may also be included in one of the implementation methods of the present disclosure, it is an obvious fact that they may be considered as a type of proposal methods. In addition, the proposal methods described above may be implemented individually or in a combination (or merger) of some of them. A rule may be defined so that information on whether or not to apply the proposal methods (or information on the rules of the proposal methods) is notified from a base station to a terminal through a predefined signal (e.g., a physical layer signal or an upper layer signal).

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
receiving at least one synchronization signal block (SSB) from a base station;
transmitting a preamble to the base station based on an SSB having a first index among the at least one SSB;
receiving a random access response from the base station in response to the preamble; and
performing an initial connection with the base station,
wherein preset transmit beamforming is formed between the base station and a reconfigurable intelligent surface (RIS), and the at least one SSB is transmitted from the base station to a terminal through the RIS based on a reflection pattern of the RIS.

2. The method of claim 1,
wherein the at least one SSB is transmitted from the base station to the RIS based on the preset transmit beamforming, and
wherein each of SSBs having different indices among the at least one SSB is transmitted to the terminal through a different beam based on the reflection pattern of the RIS.

3. The method of claim 2,
wherein the terminal measures a signal strength of the at least one SSB transmitted through each different beam, and selects the SSB having the first index having a largest measured signal strength.

4. The method of claim 3,
wherein the SSB is a RIS-associated SSB, and
wherein the RIS-associated SSB has an associated preamble and occasion.

5. The method of claim 1, wherein the RIS transfers a signal received through the preset transmit beamforming from the base station to the terminal based on a first reflection pattern corresponding to the SSB having the first index.

6. The method of claim 1,
wherein the number of terminals associated with the RIS and identification information of terminals are transferred to the base station based on the initial connection, and
wherein the base station performs multi-user access to the terminals associated with the RIS.

7. The method of claim 6, wherein the terminals associated with the RIS perform communication with the base station through the RIS based on non-orthogonal multiple access (NOMA).

8. The method of claim 6, wherein the terminals associated with the RIS perform communication with the base station through the RIS based on orthogonal multiple access.

9. The method of claim 8, wherein based on each of the terminals associated with the RIS performing communication with the base station through time division multiple access based on the RIS, the base station generates RIS time division information based on the initial connection, the RIS time division information is transferred from the base station to the RIS, and each of the terminals associated with the RIS obtains RIS time division information of each of the terminals associated with the RIS from the base station.

10. The method of claim 9, wherein the RIS transfers a signal received from the base station in a time interval corresponding to each of the terminals associated with the RIS based on the RIS time division information.

11. The method of claim 8, wherein based on each of the terminals associated with the RIS performing communication with the base station through frequency division multiple access based on the RIS, the RIS generates a beam through each of sub-array RISs and the base station and the terminals associated with the RIS perform communication based on the beam generated from each of the sub-array RISs.

12. The method of claim 11,
wherein the base station transfers a signal based on first transmit beamforming to a first sub-array RIS among the sub-array RISs in the RIS, and transfers a signal to a first terminal among the terminals associated with the RIS through a beam formed based on the first sub-array RIS, and
wherein the base station transfers a signal based on a second transmit beamforming to a second sub-array RIS among the sub-array RISs in the RIS, and transfers a signal to a second terminal among the terminals associated with the RIS through a beam formed based on the second sub-array RIS.

13. The method of claim 12,
wherein the first terminal performs communication with the base station based on the first sub-array RIS through a first frequency, and
wherein the second terminal performs communication with the base station based on the second sub-array RIS through a second frequency.

14. The method of claim 11,
wherein the sub-array RIS control value is generated by the base station through channel information of each of the terminals associated with the RIS based on the initial connection, and
wherein the sub-array RIS control value is transferred to the RIS.

15. The method of claim 14, wherein an initial recognition mode is determined based on the number of sub-arrays in the RIS and a minimum number of beams.

16. The method of claim 15,
wherein the initial recognition mode is determined based on the number of sub-arrays and the minimum number of beams that satisfy a frequency rate direction constant derived based on frequency rate learning information of a terminal direction,
wherein based on there being no combination of the number of sub-arrays and the minimum number of beams that satisfy the frequency rate direction constant, the number of sub-arrays is set to 1, and
wherein based on the number of sub-arrays being 1, the RIS generates a fixed spherical wave.

17. The method of claim 16,
wherein the terminal obtains at least one of reward information and channel state information, and generates the sub-array RIS control value through at least one of the reward information or the channel state information.

18. A method comprising:
transmitting at least one synchronization signal block (SSB);
receiving a preamble from a terminal based on an SSB having a first index among the at least one SSB;
transmitting a random access response to the terminal in response to the preamble; and
performing an initial connection with the terminal,
wherein preset transmit beamforming is formed between a base station and a reconfigurable intelligent surface (RIS), and the at least one SSB is transmitted from the base station to the terminal through the RIS based on a reflection pattern of the RIS.

19. A terminal comprising:
a transceiver; and
a processor connected to the transceiver,
wherein the processor is configured to:
control the transceiver to receive at least one synchronization signal block (SSB) from a base station;
control the transceiver to transmit a preamble to the base station based on an SSB having a first index among the at least one SSB;
control the transceiver to receive a random access response from the base station in response to the preamble; and
perform an initial connection with the base station,
wherein preset transmit beamforming is formed between the base station and a reconfigurable intelligent surface (RIS), and the at least one SSB is transmitted from the base station to the terminal through the RIS based on a reflection pattern of the RIS.

20-22. (canceled)

23. The terminal of claim 19,
wherein the at least one SSB is transmitted from the base station to the RIS based on the preset transmit beamforming, and
wherein each of SSBs having different indices among the at least one SSB is transmitted to the terminal through a different beam based on the reflection pattern of the RIS.
